(19) United States
(12) Patent Application Publication
(10) Pub. No.: US 2017/0091757 A1
(43) Pub. Date: Mar. 30, 2017

(54) TOKENIZATION PROVISIONING AND ALLOCATING SYSTEM

(71) Applicant: BANK OF AMERICA CORPORATION, Charlotte, NC (US)

(72) Inventors: Gregory Joseph Lloyd, Charlotte, NC (US); James Gregory Ronca, Decatur, GA (US); Lauren Marie Zavodny, Charlotte, NC (US); Stephen Philip Selfridge, Huntersville, NC (US); Andrew D. Kim, Glendale, AZ (US)

(21) Appl. No.: 14/870,797

(22) Filed: Sep. 30, 2015

(51) Int. Cl. G06Q 20/36; H04L 29/06; G06Q 20/38

(52) U.S. Cl. CPC G06Q 20/3672; G06Q 20/382; H04L 63/14; H04L 63/083

(57) ABSTRACT

Embodiments of the invention are directed to a system, method, or computer program product for improving the digital wallet storage system by providing hardware and software capable of provisioning, allocating, and compartmentalizing generated tokens for transaction utilization. In this way, the invention allows a user to switch out payment vehicles, payment accounts, merchants, or authorized user for one or more tokens. Thus the provisioning and allocation system allows for manipulation and provisioning of tokens, such that a user device may control the one or more payment accounts, payment vehicles, authorized users, time/date of use, and the like for each token accumulated by a user.

### BACKGROUND

Digital wallet systems or alternative tokenization payment systems use storage devices to data associated with payment information related to one or more accounts of a user. These storage devices store account number associated with an account for access by the mobile wallet system for transaction completion.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for improving the digital wallet storage system by providing hardware and software capable of provisioning, allocating, and compartmentalizing generated tokens for transaction utilization. In this way, the system may allow a user to switch out what payment vehicles use which token. Thus, the use may use a token for various credit card accounts and/or other payment vehicles, use one token for all accounts, use one token for a specific merchant, use one token for spouses, sending or receiving tokens to third parties, or the like. In this way, the user may associate different tokens with different merchants and use that token only for payments to that merchant. The token may be put on the credit card or associated with a different card or other payment vehicle. In some embodiments, for cyclical payments to a merchant, the system allows various payment vehicles to be used for different payments with common mapping. The merchant may have a series of tokens that are associated with a user, whereby when a transaction is coring the merchant may utilize the token in the bank of tokens associated with the user's selected payment vehicle. In some embodiments, the system may reach out to the user for authorization to use one or more tokens if necessary.

The user may request a token for use with an account. The token may be one-time use, generalized, authorized for use within a certain category of purchases, authorized for a certain amount, authorized for a specific time frame, or the like. The requested token is provided to the user based on the request and associated with the requested account. During a transaction, the token is passed to the merchant.

The token may be included or stored on a plastic card, on a device, or on a digital wallet. The token may include payment vehicle or account numbers. In other embodiments, the token may include a routable number that can flow through the payment processing networks just as an account number would. The system includes the infrastructure for correlation that token to the appropriate account. In this way, the account number may be completely secret from the merchant and the user during the transaction.

Embodiments of the invention relate to systems, methods, and computer program products for tokenization provisioning and allocating, the system comprising: receiving, via a distributive network, a request from a user device for a token to be communicated to the user device, wherein the token is requested for use during a transaction with a merchant; sending a blank token to the user device via a secure communicable link and storing the token on the user device; providing an interface and application for allocating the token, wherein the interface and application is stored on the user device; receiving an allocation of the token from a user via user input on the interface; providing the application an allocation coding for the token to the user device; coding the token, based on the allocation, wherein the coding includes payment account coding, payment vehicle coding, and merchant routing instructions; and allowing for toggle allowance for toggling token code between one or more payment accounts or one or more merchants.

In some embodiments, the invention further comprises cyclical mapping of transactions using the token to identify token presentation patterns to a cyclical payment merchant, wherein based on the cyclical mapping token presentation patters, automatically providing the token with the appropriate payment account associated therewith to a cyclical payment merchant.

In some embodiments, allocation of the token comprises allowing assignment of tokens with a payment account to one or more various payment vehicles, wherein a payment vehicle is a card or digital identifier accepted at the merchant to complete a transaction.

In some embodiments, the invention further comprising generating a bucket of tokens allocated to the merchant for the user and providing the bucket of tokens to the merchant for storage at the merchant to use for transactions between the user and the merchant.

In some embodiments, allocation of the token comprises provisioning the token to one or more other individuals for use for a transaction with user selected parameters. In some embodiments, allocation includes a selection of a merchant, payment vehicle, or payment account for the token. In some embodiments, allocation includes providing token limitations for using the token based on merchant, time frame, or amount of the transaction.

In some embodiments, the invention further comprising performing condition diagnostics on the user device prior to sending the user device the token, application and interface, wherein performing condition diagnostics comprises determining a security confidence rating for integration of the token and application to the user device, wherein the security confidence rating confirms that no malware is present on the user device prior to sending the token and application.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a tokenization provisioning and allocating system environment, in accordance with one embodiment of the present invention;

FIG. 2 provides a tokenization process flow, in accordance with one embodiment of the present invention;

FIG. 3 provides a tokenization process flow, in accordance with one embodiment of the present invention;

FIG. 4 provides a tokenization process flow, in accordance with one embodiment of the present invention;

FIG. 5 provides a high level process flow illustrating the tokenization provisioning and allocating process, in accordance with one embodiment of the present invention;

FIG. 6 provides a process map illustrating token provisioning and allocating options, in accordance with one embodiment of the present invention; and

FIG. 7 provides a process map illustrating utilizing a token to complete a transaction and posting of the transaction, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Presenting a credit card on a digital wallet may provide a visual bank or credit card to the user. As referred to herein, the visual bank or credit card may refer to, but is not limited to, an electronic or digital transaction vehicle that can be used to transfer money, make a payment (for a service or a good), withdraw money, and similar or related transactions. Using an approved/authorized banking channel of communication, which may include making a phone call, accessing online banking, walking into a branch banking center, using an automatic teller machine, or the like, a user may indicate that an existing physical transaction card associated with one or more financial accounts of the user is misplaced, lost, or has been misappropriated. Once the user is authenticated via the authorized banking channel, a request may be submitted for the instance issuance of a credit card. In response to the request the system may issue the credit card directly to a mobile device of the user. In that way, the user may easily display and use the virtual credit card prior to receiving the physical card for conducting a transaction.

Building an alternate payments ecosystem utilizing tokenization requires a number of entities working together in order to deliver alternative, such as near field communication (NFC) or other technology based payment services to the end users. One of the issues is the interoperability between the players and to resolve this issue the role of trusted service manager (TSM) is proposed to establish a technical ink between a user device and providers of services, so that these entities can work together. Tokenization can play a role in mediating such services.

Tokenization as a security strategy lies in the ability to replace a real card number with a token number and the subsequent limitations placed on the token number. If the token number can be used in an unlimited fashion or even in a broadly applicable manner, the token value gains as much value as the real credit card number. In these cases, the token may be secured by a second dynamic token that is unique for each transaction and also associated to a specific payment card. Examples of dynamic, transaction-specific tokens include cryptograms used in the EMV specification, and DDM mobile payment transactions.

Merchants do not always have the intricate and detailed infrastructure necessary to receive a token and process that token as a payment device or payment account for a transaction. As such, the invention provides a migration system for token processing for merchants.

Embodiments of the invention are directed to a system, method, or computer program product for a token provisioning and allocating system with specialized data feeds associated with the distributive network, specific triggering events associated with the data feeds, and data transformation throughout the data feeds to allow for user provisioning of tokens based on preference without interrupting or requiring additional token development and coding.

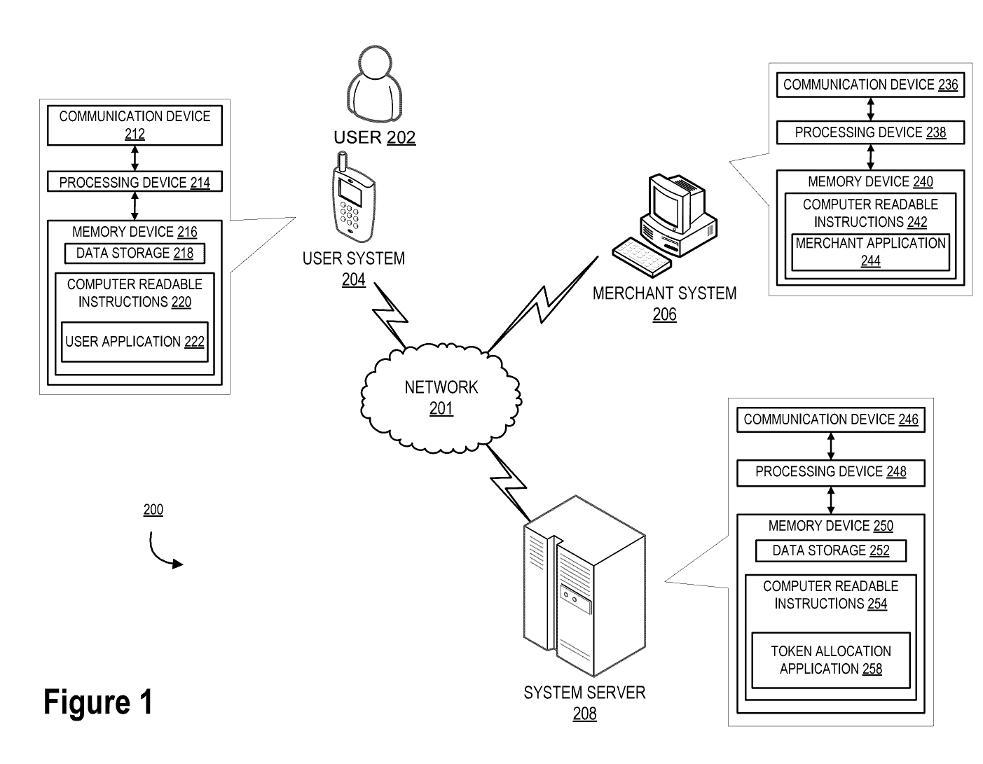

FIG. 1 illustrates a tokenization provisioning and allocating system environment 200, in accordance with one embodiment of the present invention. FIG. 1 provides the system environment 200 for which the distributive network system with specialized data feeds associated with the distributive network with specialized data feeds associated with the distributive network, specific triggering events associated with the data feeds, and data transformation throughout the data feeds to allow token allocation and provisioning. FIG. 1 provides a unique system that includes specialized servers and system communicably linked across a distributive network of nodes required to generate uniquely coded tokens and allow those tokens to be stored on a user system 204, utilized in a transaction with a merchant system 206, and to be pulled and processed for payment via the system server 208 with any allocation or provisioning desired by the user. The system, with its communicably linked diffusible network may, in some embodiments, improve a computing device if utilized thereon by improving the ability for the computer device to read and route tokens for transactions that are incompatible with a computer device. Furthermore, in some embodiments, the system may be, as described below, run on a diffusion network of specialized nodes meant for token provisioning and allocation.

As illustrated in FIG. 1, the system server 208 is operatively coupled, via a network 201 to the user system 204, and to the merchant system 206. In this way, the system server 208 can send information to and receive information from the user system 204 and the merchant system 206 for tokenization. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual consumer that is transacting with a merchant. Furthermore, the user 202 is one or more individuals that may have an online banking presents and/or a digital wallet. The user 202 may make one or more transactions to purchase a product with a credit card via a digital wallet. In some embodiments, the purchase may be made by the user 202 using a user system 204.

FIG. 1 also illustrates a user system 204. The user system 204 generally comprises a communication device 212, a processing device 214, and a memory device 216. The user system 204 is a computing system that allows a user 202 to interact with the financial institution to generate a digital or mobile wallet, access online banking applications, provision and allocate tokens via an interface, and utilize a digital wallet for transaction completion at a merchant. The processing device 214 is operatively coupled to the communication device 212 and the memory device 216. The processing device 214 uses the communication device 212 to communicate with the network 201 and other devices on the network 201, such as, but not limited to the merchant system 206 and the system server 208. As such, the communication device 212 generally comprises a modem, server, or other device for communicating with other devices on the network 201.

The user system 204 comprises computer-readable instructions 220 and data storage 218 stored in the memory device 216, which in one embodiment includes the computer-readable instructions 220 of a user application 222. In this way, a user 202 may open a financial institution account, apply for credit cards, remotely communicate with the financial institution, provision and allocate tokens, authorize and complete a transaction, or complete a transaction using the user system 204 via a digital wallet. Furthermore, the user application 222 may receive, based on instructions, a token from the system server 208 and store on the memory device 216 of the user system 204. Additionally, the user application 222 may allow a user 202 to selectably allocate and/or provision tokens to be associated with one or more payment accounts, one or more payment vehicles, one or more merchants, and/or provide tokens to additional users via text message. The user system 204 may be, for example, a desktop personal computer, a mobile system, such as a cellular phone, smart phone, personal data assistant (PDA), laptop, or the like.

As further illustrated in FIG. 1, the system server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant system 206 and the user system 204. As such, the communication device 246 generally comprises a modem, server, or other device for communicating with other devices on the network 201.

As further illustrated in FIG. 1, the system server 208 comprises computer-readable instructions 254 stored in the memory device 250, which in one embodiment includes the computer-readable instructions 254 of a token allocation application 258. In some embodiments, the memory device 250 includes data storage 252 for storing data related to the system environment, but not limited to data created and/or used by the token allocation application 258.

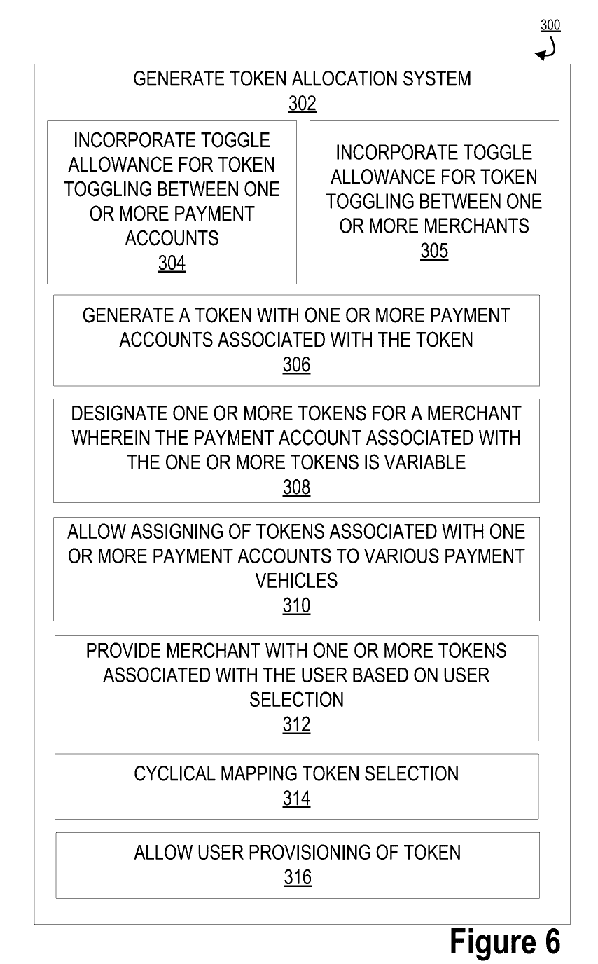

In the embodiment illustrated in FIG. 1 and described throughout much of this specification, the token allocation application 258 may generate a token allocation system associated with the tokenization provision and allocating process, which is described in further detail below in FIG. 6. In some embodiments, the token allocation application 258 may be used herein throughout interchangeable with the token allocation system. In this way, the token allocation system is associated with the system server 208 and the token allocation application 258. In some embodiments, the token allocation system may be generated by the token allocation application 258 for communication via the communication device 246 to the user system 204 for storage thereon to perform the functions of the token allocation system on the user system 204.

In some embodiments, the token allocation application 258 may create the token allocation system for provisioning and allocating tokens for a user 202. The token allocation system may be stored within the memory device 250 and be utilized to allow for provisioning and allocating of tokens for the organization and completion of a transaction at a merchant.

In some embodiments, the token allocation application 258 may create tokens with code for infrastructure processing. The token may include code therein that includes a virtual image of the card, card number, CVV number, expiration data, and other disclosures of the card required to utilize the card for digital wallet transactions. In other embodiments, the token may include code that contains a generic token number that is associated internally at the infrastructure to a user account. In this way, a token, if misappropriated, may not be utilized. Furthermore, the token allocation application 258 may further include code for routing the token, when used at a merchant, to the infrastructure for processing.

In some embodiments, the token allocation application 258 may provide the user system 204 with the token. As such, the token may be stored in the memory 216 of the user system 204 and subsequently decrypted to be used by the user system 204 as a payment means via a digital wallet. The token may also be stored and decrypted by the token allocation application 258 for reconciliation and processing of the transaction at the financial institution post digital wallet transaction.

In some embodiments, the token allocation application 258 may provide for a toggle functionality on the user system 204 for allowing the user 202 to toggle between one or more payment accounts for a specific token. In this way, token allocation application 258 may allow a single token stored on the user system 204 to be toggled between one or more accounts without the generation of another token or the re-coding of the token already stored in the user system 204. In some embodiments, the token allocation application 258 may provide for a toggle functionality allowing a user 202 to toggle the token between one or more merchants using the user system 204. In this way, the user device 204 may have a single token that the token allocation application 258 may be able to change between one or more merchants.

In some embodiments, the token allocation application 258 may generate a token with one or more payment accounts associated with that token. In this way, the token may be associated with one or more payment accounts depending on user 202 selection via the user system 204. As such, the token allocation application 258 may adjust the payment account to be associated with a token even after the token has been presented to the merchant to complete a transaction.

In some embodiments, the token allocation application 258 may communicate and designate one or more tokens for a merchant based on user 202 preferences, wherein the token allocation application 258 may change the payment account associated with the one or more tokens. In this way, the token allocation application 258 may designate or categorize tokens into an allocation for one particular merchant. In some embodiments, the token allocation application 258 may generate and provide the allocated tokens to the merchant for storage prior to a transaction.

The token allocation application 258 allows assignment of tokens associated with a payment account to one or more various payment vehicles. In this way, token allocation application 258 may associate or re-associate the token with one or more different payment vehicles, such as alternative digital wallets, a card, a fob, a pin, a user device, or the like. Furthermore, in some embodiments, the token allocation application 258 may provide a merchant via the network 201 a series of tokens that are associated with the user 202 based on the user's selection.

The token allocation application 258, in some embodiments, provides for cyclical mapping for token selection. In this way, the token allocation application 258 may learn via building historical data of user 202 cyclical payment cycles via mapping of historical trending data and the like. The token allocation application 258 may then direct payment from a token associated with the correct payment account for that cyclic payment.

Finally, the token allocation application 258 provides functionality for provisioning of one or more tokens by the user 202. In this way, the user 202 may provision a token for a specific use, such as a specific time, date, merchant, or the like. In some embodiments, the token allocation application 258 may provision the token to transfer to an individual. As such, the user 202 may request a one-time token be sent to an individual to use for one or more transactions. The token may be general for use at any merchant, transaction payment, time, or the like. In other embodiments, the token may be merchant, time, cost, or the like specific. The token allocation application 258 may transmit a useable token from the user device to a device associated with the individual via a secure communication link established by the token allocation system and secured via authorization from the user and individual.

As illustrated in FIG. 1, the merchant system 206 is connected to the system server 208 and is associated with a merchant selling products or services. In this way, while only one merchant system 206 is illustrated in FIG. 1, it is understood that multiple merchant systems may make up the system environment 200. The merchant system 206 generally comprises a communication device 236, a processing device 238, and a memory device 240. The merchant system 206 comprises computer-readable instructions 242 stored in the memory device 240, which in one embodiment includes the computer-readable instructions 242 of a merchant application 244.

In the embodiment illustrated in FIG. 1, the merchant application 244 provides products and services to a user 202 and is part of one or more user transactions. In some embodiments, the merchant application 244 may be part of a network associated with the merchant that provides products and services to a user 202 via online or mobile means. Furthermore, the merchant application 244 may be associate with a brink-and-mortar merchant location. As such, the merchant application 244 may be a part of one or more user transactions when the user 202 transacts with the merchant.

Furthermore the merchant application 244 may receive one or more tokens as a payment vehicle for a transaction at the merchant. Furthermore, the merchant application 244 may recognize code embedded within the token and process the transaction using the payment account associated with the transaction. Furthermore, the merchant application 244 may store one or more tokens associated with a user 202 for future transactions.

It is understood that the servers, systems, and devices described herein illustrate one embodiment of the invention. It is further understood that one or more of the servers, systems, and devices can be combined in other embodiments and still function in the same or similar way as the embodiments described herein.

The present invention relates to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly, or within one or more digital wallets associated with the payment devices. In other embodiments, the tokens may be associated with electronic transactions that are made over the Internet instead of using a physical payment device. Utilizing a token as a payment instrument instead of actual account information, and specifically an account number improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear or are erased, while multi-use tokens may be utilized more than once before they disappear or are erased.

Tokens may be 16-digit numbers like credit, debit, or other like account numbers, may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token in order to represent the user account information (e.g., account number, user name, pin number, or the like). In other embodiments of the invention, the digital wallet may store some or all of the user account information, including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiment this may be the merchant) or another third party that stores the token, and the transaction may be processed accordingly.

Specific tokens, in some embodiments, may be tied to a single user account, but in other embodiments, may be tied to multiple user accounts, as will be described throughout this application. Moreover, the tokens may be associated with a specific digital wallet or multiple digital wallets based on the institutions and accounts with which the tokens may be associated. Moreover, the tokens themselves, or the user accounts, users, digital wallets, or the like associated with the tokens may have limitations that limit the transactions that the users may enter into using the tokens. The limitations may include, limiting the transactions of the user to a single merchant, a group of multiple merchants, merchant categories, single products, a group a products, product categories, transaction amount limits, transaction numbers, geographic locations, or other like limits as is described herein.

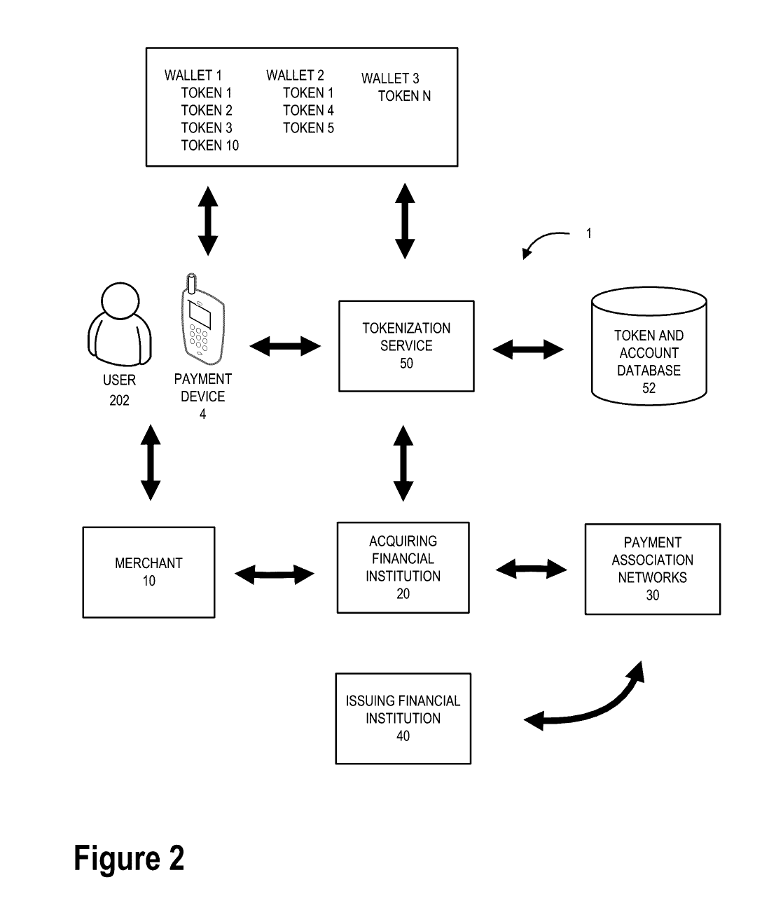

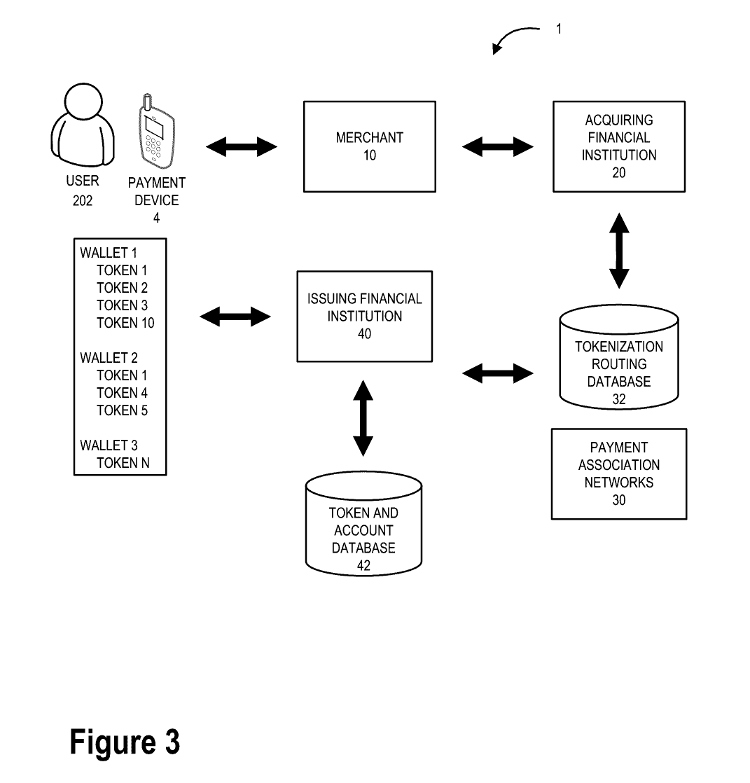

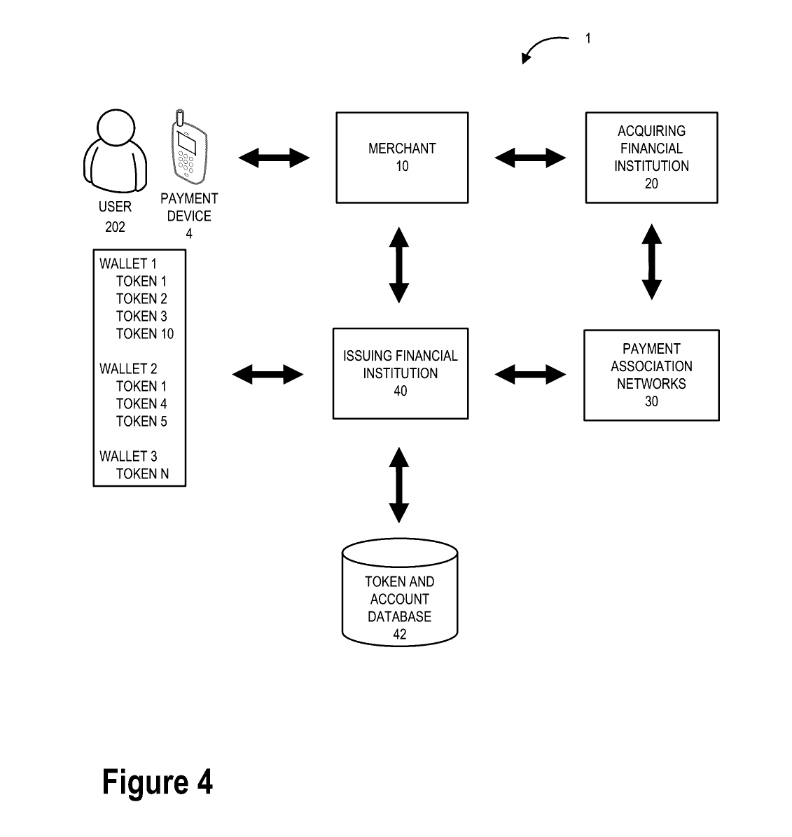

FIGS. 2 through 4 illustrate a number of different ways that the user 202 may use one or more tokens in order to enter into a transaction and make payments associated with the transaction. FIG. 2, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 2 (as well as in FIGS. 3 and 4), a user 202 may utilize a payment device 4 (or in other embodiments a payment instrument over the Internet) to enter into a transaction. FIG. 2 illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like). As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument may be used to enter into the transaction. The payment instrument may be the same as the token or digital wallet associated with the payment device 4, except they are not associated with specific payment device. For example, the token or digital wallet may be associated with an application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 202 with the one or more payment devices 4 may utilize the token. Alternatively, the payment device 4 may have one or more digital wallets stored on the payment device 4 that allow the user 202 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 202 and merchants 10.

As illustrated in FIG. 2, a tokenization service 50 may be available for the user 202 to use during transactions. As such, before entering into a transaction, the user 202 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, or the like) associated with the token that may limit the transactions in which the user 202 may enter. The limits may be placed on the token by the user 202, or another entity (e.g., person, company, or the like) responsible for the transactions entered into by the user 202 using the account associated with the token. The generation of the token may occur at the time of the transaction or well in advance of the transaction, as a one-time use token or multi-use token.

After or during creation of the token the user 202 enters into a transaction with a merchant 10 using the payment device 4 (or payment instrument over the Internet). In some embodiments the user 202 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 202 is entering with the merchant 10.

The merchant 10 submits the token (as well as any user account information not substituted by a token) and the transaction information for authorization along the normal processing channels (also described as processing rails), which are normally used to process a transaction made by the user 202 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described is when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the transaction is allowed), then the acquiring financial institution 20 thereafter sends the user account number, the other user information, and the transaction information directly to the issuing financial institution 40, or otherwise indirectly through the card association networks 30. The financial institution determines if the user 202 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 202 is completed. After the transaction is completed the token may be deleted, erased, or the like if it is a single-use token, or stored for further use if it is a multi-use token.

The embodiment illustrated in FIG. 2 prevents the user account number and other user information from being presented to the merchant 10; however, the tokenization service 50, acquiring financial institution 20, the card association networks 30, and the issuing financial institution 40 all utilize the actual user account number and other user information to complete the transaction.

FIG. 3 illustrates another embodiment of a token system 1, in which the user 202 may utilize a payment device 4 (or payment instrument over the Internet) to enter into transactions with merchants 10 utilizing tokens instead of user account numbers. As illustrated in FIG. 3, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 202 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 4). In other embodiments, the issuing financial institution 40 may create the digital wallet for the user 202 (e.g., for through a wallet created for a business client or retail client associated with the user 202) and include one or more tokens for various types of transactions, products, or the like. The issuing financial institution 40 may store the tokens, the associated user account information (e.g., including the user account number), and any limits on the use of the token, as was previously described with respect to the tokenization service 50. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 202 may enter into a transaction with the merchant 10 using a payment device 4 (or a payment instrument through the Internet). In one embodiment the user 202 may enter into the transaction with a token associated with the payment device 4 itself (or a payment instrument through the Internet). In other embodiments, a specific digital wallet and/or a specific account within the digital wallet may be selected for a particular merchant with whom the user 202 wants to enter into a transaction. For example, the user 202 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with tokens and the corresponding issuing financial institutions 40 to which transactions associated with the tokens should be routed.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token or the user account associated with the token. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 3 allows the user and the financial institution to shield the user's account number and other user information from all of the entities in the payment processing system because the merchant 10, acquiring merchant bank 20, payment association networks 30, or other institutions in the payment processing system only used the token and/or other shielded user information to process the transaction. Only the issuing financial institution 40 has the actual account number of the user 202.

FIG. 4 illustrates another embodiment of the token system 1, in which the user 202 may utilize a payment device 4 (or payment instrument over the Internet) to enter into transactions with a merchant 10 utilizing a token instead of a user account number and/or other user account information. As illustrated in FIG. 4, the user 202 may have one or more tokens stored in the payment device 4, which may be associated with one or more digital wallets, or one or more user accounts within the digital wallets. The one or more tokens may be stored in the user's payment device 4 (or on the digital wallet), or stored on a cloud or other service through the issuing financial institution 40 or another institution. The user 202 may set up the digital wallet by communicating with the issuing financial institution 40 (e.g., the user's financial institution) and/or the merchant 10 to request a token for the payment device 4, either for the device itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 202 that may be specifically associated with the merchant 10. For example, the issuing financial institution may provide a set of tokens to “merchant 1” to associate with “wallet 1” that may be used by one or more users 202. As such “Token 10” may be associated with “wallet 1” and be specified only for use for transactions with “merchant 1.”

The merchant 10 may provide the specific tokens from the financial institution 40 to the user 202, while the financial institution 40 may store the user account information with the token provided to the user 202. The financial institution may communicate directly with the user 202, or through the merchant 10 in some embodiments, in order to associate the token with the user 202. Since the merchant 10 provides, or is at least notified by the financial institution 40, that a specific token, or groups of tokens, are associated with a specific issuing financial institution 40, then the merchant 10 may associate routing information and transaction information with the token when the user 202 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information directly to the issuing financial institution 40, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 202 that the transaction is allowed or denied.

As is the case with the token system 2 in FIG. 3, the token system in FIG. 4 allows the user 202 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 202.

The embodiments of the invention illustrated in FIGS. 2 through 4 are only example embodiments of the invention, and as such it should be understood that combinations of these embodiments, or other embodiments not specifically described herein may be utilized in order to process transactions between a user 202 and merchant 10 using one or more tokens as a substitute for user account numbers or other user account information, such that the merchant, or even other institutions in the payment processing system do not have access to the actual user accounts or account information.

As briefly discussed above, if the issuing financial institution 40 creates the digital wallet not only does the financial institution 40 receive transaction information along the normal processing channels, but the financial institution 50 may also receive additional transaction information from the user 202 through the digital wallet using the application program interfaces (APIs) or other application created for the digital wallet. For example, geographic location information of the user 202, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 202, the issuing financial institution 40 may not receive all the transaction information from the traditional transaction processing channels or from the digital wallet. As such, the issuing financial institution 40 may have to receive additional transaction information from another application associated with the user 202 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the user enters into transactions using the digital wallets.

Moreover, when there is communication between the digital wallets of the users 202 and the issuing financial institution 40 or another institution, transactions in which the user 202 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 2 through 4.

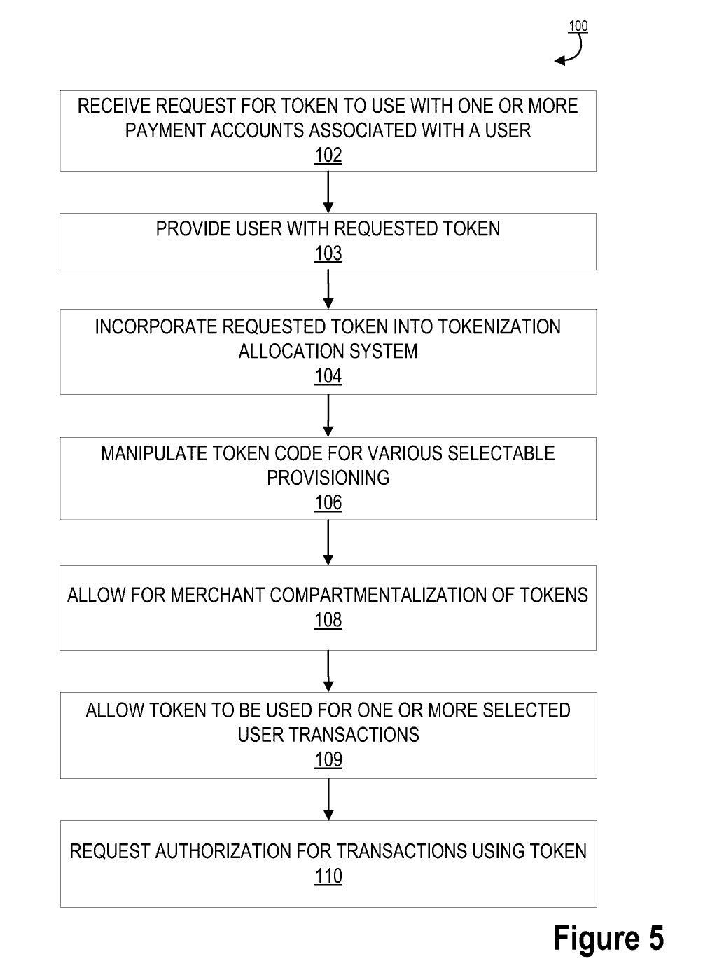

FIG. 5 provides a high level process flow illustrating the tokenization provisioning and allocating process 100, in accordance with one embodiment of the present invention. As illustrated in block 102, the process is initiated by receiving a request for a token to be used with one or more payment accounts associated with a user. In this way, the user may have one or more payment accounts such as a credit card account, a debit card account, a checking account, or the like. The user may desire that one or more of these accounts to be associated with a mobile means of transacting, such as a mobile wallet or other digital or mobile methods of transacting. In some embodiments, the token may comprise information for a soft or virtual credit card for use via digital wallet. In some embodiments, the system may provide the token to the digital wallet. The token may be stored in the memory of the user device associated with the digital wallet. The token may include a virtual image of the card, card number, CVV number, expiration data, and other disclosures of the card required to utilize the card for digital wallet transactions. In yet other embodiments, the token may comprise a unique token number and no identifiable information on it. In this way, the system may associate the token with an account after the token has been used for a transaction, thus preventing account number dissemination.

Next, as illustrated in block 103, the system may generate and provide the user with a token based on the user's request. The token may be stored within the user's mobile device, stored in a plastic card, or the like. As illustrated in block 104, the token may then be incorporated into a tokenization allocation system. In this way, the tokenization allocation system may be able to manipulate the token based on requests from the user.

As illustrated in block 106, the token may be manipulated by the system to code for various selectable provisions or allocations the user may desire. In this way, the system may allow a user to switch out what payment vehicles use which token. Thus, the use may use a token for various credit card accounts and/or other payment vehicles, use one token for all accounts, use one token for a specific merchant, use one token for spouses, sending or receiving tokens to third parties, or the like. In this way, the user may associate different tokens with different merchants and use that token only for payments to that merchant. The token may be put on the credit card or associated with a different card or other payment vehicle. In some embodiments, for cyclical payments to a merchant, the system allows various payment vehicles to be used for different payments with common mapping.

Next, in some embodiments, as illustrated in block 108, the system may allow a user to compartmentalize tokens based on merchant. In this way, the compartmentalized tokens may only be used for that merchant. Compartmentalization may done via data storage or memory associated with the user device. In this way, the tokenization allocation system may communicate with the user device for compartmentalization. In other embodiments, the tokenization allocation system may be sent to and stored on the user device for implementation.

Next, as illustrated in block 109, the system may allow a token to be used for one or more user selected transaction. In this way, the system is able to utilize a token for multiple transactions using multiple payment accounts. Finally, as illustrated in block 110, the system may, in some embodiments reach out to the user to request authorization to use a token for a transaction. In this way, the system may automatically select a token to provide to a merchant for a transaction, based on previous allocations or provisions. Once the token is selected, the system may confirm and/or authorize the use of the token with the user.

FIG. 6 illustrates a process map for token provisioning and allocating options 300, in accordance with one embodiment of the present invention. As illustrated, the token allocation system may be generated in block 302. In some embodiments, the token allocation system may be communicated to and stored on a user device. In other embodiments, the token allocation system may be a centralized system with closed secure data feeds and communication signals between itself and the user device.

In some embodiments, the token allocation system may incorporate a toggle functionality allowing for a token to toggle between one or more payment accounts, as illustrated in block 304. In this way, the token allocation system may allow a single token stored on the user device to be toggled between one or more accounts without the generation of another token or the re-coding of the token already stored in the user device.

In some embodiments, the token allocation system may incorporate a toggle functionality allowing for a token to toggle between one or more merchants, as illustrated in block 305. In this way, the user system may have a single token that the token allocation system may be able to change between one or more merchants. As such, that token may be usable only at the one or more merchants that were selected.

In some embodiments, the token allocation system may generate a token with one or more payment accounts associated with that token, as illustrated in block 306. In this way, the token may be associated with one or more payment accounts depending on user selection of the product, merchant, or the like. As such, the token allocation system may be able to toggle between payment accounts associated with the token even after the token has been presented to the merchant to complete a transaction.

In some embodiments, the token allocation system may designate one or more tokens for a merchant wherein the payment account associated with the one or more tokens can be varied, as illustrated in block 308. In this way, the token allocation system may designate or categorize tokens into an allocation for one particular merchant. In some embodiments, the token allocation system may provide the allocated tokens to the merchant for storage prior to a transaction. In other embodiments, the token allocation system may store the tokens in a data store associated with that merchant. While the token may be designated for that specific merchant, the token allocation system may be able to manipulate or universally change the payment account associated with the token. The token allocation system may incorporate the payment account information or alias token information associated with that payment account, for misappropriation protection, and allow the user to access and use that merchant specific token for a transaction with the specific merchant but using various payment accounts.

As illustrated in block 310, the token allocation system allows assignment of tokens associated with a payment account to one or more various payment vehicles. In this way, the token allocation system may associate or re-associate the token with one or more different payment vehicles, such as alternative digital wallets, a card, a fob, a pin, a user device, or the like. As such, the user may direct any token associated with any payment account to one or more different payment vehicles in order to utilize the payment vehicle at a point of transaction to complete a transaction.

As illustrated in block 312, the token allocation system may provide a merchant with a series of tokens that are associated with the user based on the user's selection. As such, when a transaction is initiated by a user, the merchant can use one or more tokens in the series of tokens provided to the merchant to complete the transaction. In this way, no account information or alternative payment information may need to be provided to the merchant from the user to complete the transaction.

As illustrated in block 314, the token allocation system may provide for cyclical mapping for token selection. In this way, the token allocation system may learn user cyclical payment cycles via mapping. The token allocation system may then direct payment from a token associated with the correct payment account for that cyclic payment, irrespective of the current payment vehicle that may be associated with that token. In this way, no matter the token allocation or provisioning, the token allocation system may maintain consistency for cyclical payment cycle payments.

As illustrated in block 316, the token allocation system may allow for user provisioning of one or more tokens. In some embodiments, the provisioning may be performed by the token allocation system for a specific user. In this way, the user may provision a token for a specific use, such as a specific time, date, geo-location, spend limit, merchant, or the like. In some embodiments, the token allocation system may provision the token to transfer to an individual. As such, the user may request a one-time token be sent to an individual to use for one or more transactions. The token may be general for use at any merchant, transaction payment, time, or the like. In other embodiments, the token may be merchant, geo-location, time, cost, or the like specific. Furthermore, the token may include a specific spend limit. The token allocation system may transmit a useable token from the user device to a device associated with the individual via a secure communication link established by the token allocation system and secured via authorization from the user and individual.

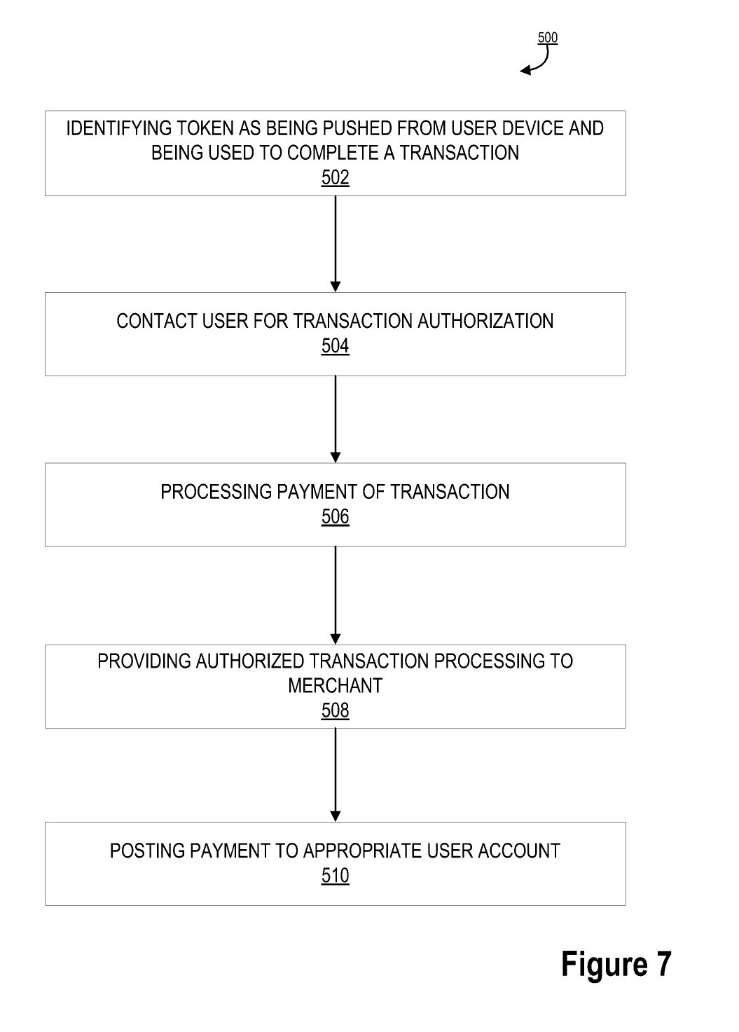

FIG. 7 illustrates a process map for utilizing a token to complete a transaction and posting of the transaction 500, in accordance with one embodiment of the present invention. As illustrated in block 502, the process 500 is initiated by identifying a token as being pushed from the user device to a merchant to complete a transaction. In this way, the user may be attempting to complete a transaction using a mobile wallet or the like. The user device may push the token to a merchant device as a payment for a transaction with the merchant. The pushing may be completed automatically based on the tokenization allocation system. In other embodiments, the user may select the token payment account associated with the token to complete the transaction.

Next, as illustrated in block 504, in some embodiments, the system may contact the user to confirm use of the selected token for the transaction. In this way, when the system selects the token for the transaction based on allocations or provisioning, the system may wish to confirm the selected token prior to processing the transaction using that token.

Next, as illustrated in block 506, the token may be used as a payment device and be processed for payment of the transaction. Along with the token, transaction information associated with the transaction may be received to complete the transaction. This information may include details about the merchant, location, products purchased, and total purchase price of the transaction. In some embodiments, the transaction information may be received with the token. In other embodiments, the transaction information may be sent independent of the token.

Once processed, the authorized transaction processing is posted to the merchant, as illustrated in block 508. Then the transaction may be completed. Finally, after providing authorization to complete the transaction to the merchant, the system may post the transaction to the appropriate user account, as illustrated in block 510.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 6858US1.014033.2532 | To Be Assigned | MERCHANT TOKENIZATION | Concurrently |
| | | MIGRATION INFRASTRUCTURE | Herewith |
| | | SYSTEM | |
| 6860US1.014033.2534 | To Be Assigned | NON-INTRUSIVE GEO- | Concurrently |
| | | LOCATION DETERMINATION | Herewith |
| | | ASSOCIATED WITH | |
| | | TRANSACTION | |
| | | AUTHORIZATION | |
| 6860US2.014033.2535 | To Be Assigned | NON-INTRUSIVE GEO- | Concurrently |
| | | LOCATION DETERMINATION | Herewith |
| | | ASSOCIATED WITH | |
| | | TRANSACTION | |
| | | AUTHORIZATION | |
| 6803US1.014033.2557 | To Be Assigned | SYSTEM FOR ELECTRONIC | Concurrently |
| | | COLLECTION AND DISPLAY OF | Herewith |
| | | ACCOUNT TOKEN USAGE AND | |
| | | ASSOCIATION | |
| 6861US1.014033.2537 | To Be Assigned | TOKEN PROVISIONING FOR | Concurrently |
| | | NON-ACCOUNT HOLDER USER | Herewith |
| | | WITH LIMITED TRANSACTION | |
| | | FUNCTIONS | |
| 6862US1.014033.2538 | To Be Assigned | ACCOUNT TOKENIZATION FOR | Concurrently |
| | | VIRTUAL CURRENCY | Herewith |
| | | RESOURCES | |

What is claimed is:

1. A system for tokenization provisioning and allocating, the system comprising:
a memory device with non-transitory computer-readable program code stored thereon;
a communication device;
a processing device operatively coupled to the memory device and the communication device within a distributive network for the approval, wherein the processing device is configured to execute the computer-readable program code to:
receiving, via a distributive network, a request from a user device for a token to be communicated to the user device, wherein the token is requested for use during a transaction with a merchant;
sending a blank token to the user device via a secure communicable link and storing the token on the user device;
providing an interface and application for allocating the token, wherein the interface and application is stored on the user device;
receiving an allocation of the token from a user via user input on the interface;
providing the application an allocation coding for the token to the user device;
coding the token, based on the allocation, wherein the coding includes payment account coding, payment vehicle coding, and merchant routing instructions; and
allowing for toggle allowance for toggling token code between one or more payment accounts or one or more merchants.

2. The system of claim 1 further comprising cyclical mapping of transactions using the token to identify token presentation patterns to a cyclical payment merchant, wherein based on the cyclical mapping token presentation patters, automatically providing the token with the appropriate payment account associated therewith to a cyclical payment merchant.

3. The system of claim 1, wherein allocating the token comprises allowing assignment of tokens with a payment account to one or more various payment vehicles, wherein a payment vehicle is a card or digital identifier accepted at the merchant to complete a transaction.

4. The system of claim 1 further comprising generating a bucket of tokens allocated to the merchant for the user and providing the bucket of tokens to the merchant for storage at the merchant to use for transactions between the user and the merchant.

5. The system of claim 1, wherein allocating the token comprises provisioning the token to one or more other individuals for use for a transaction with user selected parameters.

6. The system of claim 1, wherein allocating the token includes a selection of a merchant, payment vehicle, or payment account for the token.

7. The system of claim 1, wherein allocating the token includes providing token limitations for using the token based on merchant, time frame, or amount of the transaction.

8. The system of claim 1 further comprising performing condition diagnostics on the user device prior to sending the user device the token, application and interface, wherein performing condition diagnostics comprises determining a security confidence rating for integration of the token and application to the user device, wherein the security confidence rating confirms that no malware is present on the user device prior to sending the token and application.

9. A computer program product for tokenization provisioning and allocating, the computer program product, within a distributive network for the convergence and divergence analysis, comprising at least one non-transitory computer-readable medium having computer-readable program code portions embodied therein, the computer-readable program code portions comprising:
an executable portion configured for receiving, via a distributive network, a request from a user device for a token to be communicated to the user device, wherein the token is requested for use during a transaction with a merchant;
an executable portion configured for sending a blank token to the user device via a secure communicable link and storing the token on the user device;
an executable portion configured for providing an interface and application for allocating the token, wherein the interface and application is stored on the user device;
an executable portion configured for receiving an allocation of the token from a user via user input on the interface;
an executable portion configured for providing the application an allocation coding for the token to the user device;
an executable portion configured for coding the token, based on the allocation, wherein the coding includes payment account coding, payment vehicle coding, and merchant routing instructions; and
an executable portion configured for allowing for toggle allowance for toggling token code between one or more payment accounts or one or more merchants.

10. The computer program product of claim 9 further comprises an executable portion configured for cyclical mapping of transactions using the token to identify token presentation patterns to a cyclical payment merchant, wherein based on the cyclical mapping token presentation patters, automatically providing the token with the appropriate payment account associated therewith to a cyclical payment merchant.

11. The computer program product of claim 9, wherein allocating the token comprises allowing assignment of tokens with a payment account to one or more various payment vehicles, wherein a payment vehicle is a card or digital identifier accepted at the merchant to complete a transaction.

12. The computer program product of claim 9 further comprising an executable portion configured for generating a bucket of tokens allocated to the merchant for the user and providing the bucket of tokens to the merchant for storage at the merchant to use for transactions between the user and the merchant.

13. The computer program product of claim 9, wherein allocating the token comprises provisioning the token to one or more other individuals for use for a transaction with user selected parameters.

14. The computer program product of claim 9, wherein allocating the token includes a selection of a merchant, payment vehicle, or payment account for the token.

15. The computer program product of claim 9, wherein allocating the token includes providing token limitations for using the token based on merchant, time frame, or amount of the transaction.

16. The computer program product of claim 9 further comprising an executable portion configured for performing condition diagnostics on the user device prior to sending the user device the token, application and interface, wherein performing condition diagnostics comprises determining a security confidence rating for integration of the token and application to the user device, wherein the security confidence rating confirms that no malware is present on the user device prior to sending the token and application.

17. A computer-implemented method for tokenization provisioning and allocating, the method comprising:
providing a computing system within a distributive network for the authorization and instant integration approval for a digital wallet, comprising a computer processing device and a non-transitory computer readable medium, where the computer readable medium comprises configured computer program instruction code, such that when said instruction code is operated by said computer processing device, said computer processing device performs the following operations:
receiving, via a distributive network, a request from a user device for a token to be communicated to the user device, wherein the token is requested for use during a transaction with a merchant;
sending a blank token to the user device via a secure communicable link and storing the token on the user device;
providing an interface and application for allocating the token, wherein the interface and application is stored on the user device;
receiving an allocation of the token from a user via user input on the interface;
providing the application an allocation coding for the token to the user device;
coding the token, based on the allocation, wherein the coding includes payment account coding, payment vehicle coding, and merchant routing instructions; and
allowing for toggle allowance for toggling token code between one or more payment accounts or one or more merchants.

18. The computer implemented method of claim 17 further comprising cyclical mapping of transactions using the token to identify token presentation patterns to a cyclical payment merchant, wherein based on the cyclical mapping token presentation patters, automatically providing the token with the appropriate payment account associated therewith to a cyclical payment merchant.

19. The computer implemented method of claim 17, wherein allocating the token comprises allowing assignment of tokens with a payment account to one or more various payment vehicles, wherein a payment vehicle is a card or digital identifier accepted at the merchant to complete a transaction.

20. The computer implemented method of claim 17 further comprising generating a bucket of tokens allocated to the merchant for the user and providing the bucket of tokens to the merchant for storage at the merchant to use for transactions between the user and the merchant.

21. The computer implemented method of claim 17, wherein allocating the token includes providing token limitations for using the token based on merchant, time frame, or amount of the transaction.

22. The computer implemented method of claim 17 further comprising performing condition diagnostics on the user device prior to sending the user device the token, application and interface, wherein performing condition diagnostics comprises determining a security confidence rating for integration of the token and application to the user device, wherein the security confidence rating confirms that no malware is present on the user device prior to sending the token and application.
